(19) United States
(12) Patent Application Publication
(10) Pub. No.: US 2026/0223251 A1
(43) Pub. Date: Jul. 30, 2026

(54) USER EQUIPMENT (UE) AGGREGATED MAXIMUM BIT RATE (AMBR) FOR EMERGENCY SERVICES

(71) Applicant: Telefonaktiebolaget LM Ericsson (publ), Stockholm (SE)

(72) Inventors: Nianshan SHI, Järfälla (SE); Qian CHEN, Mölndal (SE); Shabnam SULTANA, Montreal (CA)

(21) Appl. No.: 19/146,426

(22) PCT Filed: Jan. 9, 2024
(86) PCT No.: PCT/IB2024/050217

§ 371 Date: Jul. 8, 2025

Related U.S. Application Data
(60) Provisional application No. 63/479,096, filed on Jan. 9, 2023.

(51) Int. Cl. H04W 76/50; H04L 65/1016; H04W 4/90; H04W 28/02

(52) U.S. Cl. CPC H04W 76/50; H04L 65/1016; H04W 4/90; H04W 28/0268

(57) ABSTRACT

A method, system and apparatus are disclosed. According to some embodiments, a core network node is provided. The core network node includes processing circuitry configured to: store a local User Equipment, UE, Aggregated Maximum Bit Rate, AMBR, parameter to be applied for any UE requesting emergency services, after storing the local UE AMBR parameter, receive a request for an emergency service from a first UE via an access network node, and cause sending, to the access network node, a message comprising including the local UE AMBR parameter for emergency service set up for the first UE.

### FIELD

The present disclosure relates to wireless communications, and in particular, to network functions when wireless device (e.g., UE) Aggregate Maximum Bit Rate (AMBR) is unavailable.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

In particular, in 5G, the wireless device Aggregate Maximum Bit Rate (AMBR) (e.g., user equipment (UE) AMBR) limits the aggregate bit rate that can be expected to be provided across all Non-Guaranteed Bit Rate (non-GBR) Quality of Service (QoS) Flows of a wireless device (e.g., UE). Each (R) AN sets its UE AMBR to the sum of the Session-AMBR of all PDU Sessions with active user plane to this (R) AN up to the value of the UE AMBR received from Access and Mobility Function (AMF). The UE AMBR is a parameter provided to the (R) AN by the AMF based on the value of the subscribed UE AMBR retrieved from UDM or the dynamic serving network UE AMBR retrieved from policy control function (PCF) (e.g., for roaming subscriber). The AMF provides the UE AMBR provided by PCF to (R) AN if available. The UE AMBR is measured over an AMBR averaging window which may be a standardized value. The UE AMBR is not applicable to GBR QoS Flows.

UE AMBR is signaled to NG-RAN node (e.g., network node, gNB, etc.) either in the initial wireless device Context Setup procedure or in PDU session resource Setup procedure. When a non-GBR QoS is setup, it is mandatory according to the 3GPP specification that the UE AMBR is sent to NG-RAN node.

In some cases when making or performing emergency access via packet core, the wireless device may not be able to register to the network, thus remain unauthenticated, or it does not have a Universal Integrated Circuit Card (UICC) thus no UDM records, this wireless device by regulation of certain countries should/must be allowed to setup emergency service.

An unauthenticated wireless device might be the case that the wireless device without Universal Subscriber Identity Module (USIM) or wireless device with USIM but failed the authentication. There may also be a scenario that the wireless device is authenticated (via Authentication Server Function (AUSF)), but AMF failed to receive wireless device subscription data from UDM.

When the emergency service is setup, it is based on the DNN (e.g., Data Network Name) configured in the serving network for emergency service and there may be a QoS flow for IP Multimedia Subsystem (IMS) signaling (non-GBR service) and a QoS flow for conversational voice (GBR service) in case the emergency access is voice.

According to 3GPP standards, the emergency service cannot be setup in NG-RAN node since AMF may not be able to provide the UE AMBR in certain cases, but NG-RAN node requires the UE AMBR for the non-GBR IMS signaling.

Hence, 3GPP does not define the procedures to support the emergency service setup when the UE AMBR cannot be obtained by the AMF, and sent from the AMF to NG-RAN node during the emergency service setup procedure

### SUMMARY

Some embodiments advantageously provide methods, systems, and apparatuses for network functions when UE Aggregate Maximum Bit Rate (AMBR) is unavailable. One or more embodiments provides both Core Network (CN) based solution and Radio Access Network (RAN) based solution for the emergency service to setup even without UE AMBR available from UDM or PCF (e.g., the wireless device is not authenticated or the wireless device is authenticated without UE AMBR), or the wireless device is authenticated (via AUSF), but AMF failed to get wireless device subscription data from UDM or UE AMBR is not available from UDM or PCF since the wireless device does not have subscription (no UICC).

According to one aspect of the present disclosure, a core network node is provided. The core network node comprises processing circuitry configured to: store a local User Equipment, UE, Aggregated Maximum Bit Rate, AMBR, parameter to be applied for any UE requesting emergency services, after storing the local UE AMBR parameter, receive a request for an emergency service from a first UE via an access network node, and cause sending, to the access network node, a message comprising the local UE AMBR parameter for emergency service set up for the first UE.

According to one or more embodiments of this aspect, the processing circuitry is further configured to determine that the core network node does not have stored subscription data for the first UE, the sending of the message comprising the local UE AMBR parameter being based on the determination.

According to one or more embodiments of this aspect, the sending of the message comprising the local UE AMBR parameter is based on UE AMBR parameter not being obtained from a network entity.

According to one or more embodiments of this aspect, the network entity is a Unified Data Manager, UDM, node.

According to one or more embodiments of this aspect, the network entity is a Policy Control Function, PCF, node.

According to one or more embodiments of this aspect, the core network node is an Access and Mobility Management Function, AMF.

According to one or more embodiments of this aspect, the emergency service corresponds to an Internet Protocol Multimedia Subsystem, IMS, emergency session.

According to one or more embodiments of this aspect, the processing circuitry is further configured to: after storing the local UE AMBR parameter, receive a request for an emergency service from a second UE via the access network node, and cause sending, to the access network node, a message comprising the local UE AMBR parameter for emergency service set up for the second UE.

According to one or more embodiments of this aspect, the local UE AMBR parameter is stored as part of emergency configuration data that are applied to emergency services.

According to another aspect of the present disclosure, a method implemented by a core network node is provided. The method comprises storing a local User Equipment, UE, Aggregated Maximum Bit Rate, AMBR, parameter to be applied for any UE requesting emergency services, after storing the local UE AMBR parameter, receiving a request for an emergency service from a first UE via an access network node, and sending, to the access network node, a message comprising the local UE AMBR parameter for emergency service set up for the first UE.

According to one or more embodiments of this aspect, the method further comprises determining that the core network node does not have stored subscription data for the first UE, the sending of the message comprising the local UE AMBR parameter being based on the determination.

According to one or more embodiments of this aspect, the sending of the message comprising the local UE AMBR parameter is based on UE AMBR parameter not being obtained from a network entity.

According to one or more embodiments of this aspect, the network entity is a Unified Data Manager, UDM, node.

According to one or more embodiments of this aspect, the network entity is a Policy Control Function, PCF, node.

According to one or more embodiments of this aspect, the core network node is an Access and Mobility Management Function, AMF.

According to one or more embodiments of this aspect, the emergency service corresponds to an Internet Protocol Multimedia Subsystem, IMS, emergency session. According to one or more embodiments of this aspect, the method further comprises, after storing the local UE AMBR parameter, receiving a request for an emergency service from a second UE via the access network node.

According to one or more embodiments of this aspect, sending, to the access network node, a message comprising the local UE AMBR parameter for emergency service set up for the second UE.

According to one or more embodiments of this aspect, the local UE AMBR parameter is stored as part of emergency configuration data that are applied to emergency services.

According to another aspect of the present disclosure, a computer readable medium stores program instructions that, when executed by a processor, configure the processor to implement one or more methods described herein.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node according to some embodiments of the present disclosure;

FIG. 8 is a flowchart of an example process in a core network node according to some embodiments of the present disclosure; and

FIG. 9 is a flowchart of another example process in a core network node according to some embodiments of the present disclosure.

### DETAILED DESCRIPTION

Before describing in detail example embodiments, it is noted that the embodiments reside primarily in combinations of apparatus components and processing steps related to network functions when UE AMBR is unavailable, not received and/or checked. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments relate to network functions when UE Aggregate Maximum Bit Rate (AMBR) is unavailable.

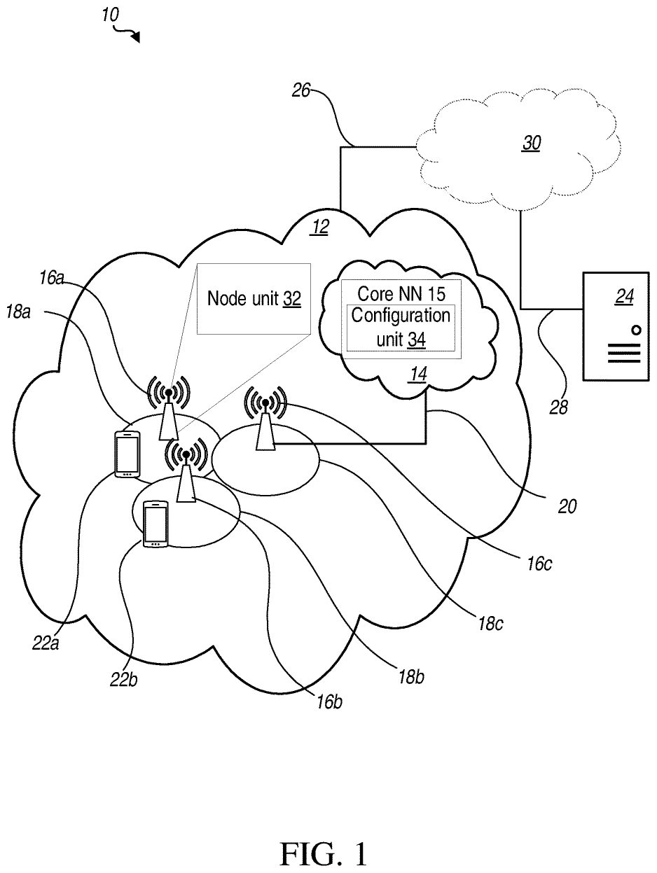

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The core network 14 includes one or more core network nodes 15 (collectively referred to as core network node 15) for performing one or more core network functions. The core network node may be one or more of an AMF, UDM, PCF, etc. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected

WD 22a. Similarly, the network node 16 need not be aware of the future routing of an outgoing uplink communication originating from the WD 22a towards the host computer 24.

A network node 16 is configured to include a node unit 32 which is configured to perform one or more network node 16 functions as described herein such as with respect to network functions when UE AMBR is unavailable. A core network node 15 is configured to include a configuration unit 34 which is configured to perform one or more core network node 15 functions as described herein such as with respect to network functions when UE AMBR is unavailable.

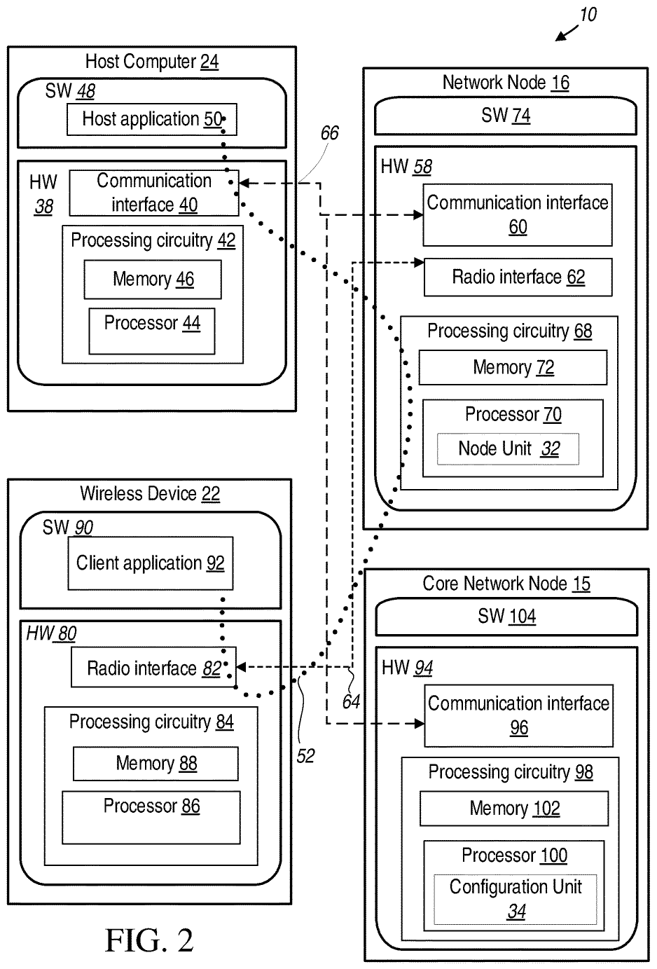

Example implementations, in accordance with an embodiment, of the WD 22, network node 16, core network node 15 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16, core network node 15 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24 and/or core network node 15. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include node unit 32 configured to perform one or more network node 16 function as described herein such as with respect to network functions when UE AMBR is unavailable.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

The communication system 10 further includes a core network node 15 provided in a communication system 10 and including hardware 94 enabling it to communicate with the host computer 24 and with the network node 16. The hardware 94 may include a communication interface 96 for setting up and maintaining a wired or wireless connection with an interface of a different communication device of the communication system 10.

In the embodiment shown, the hardware 94 of the network node 16 further includes processing circuitry 98. The processing circuitry 98 may include a processor 100 and a memory 102. In particular, in addition to or instead of a processor, such as a central processing unit, and memory, the processing circuitry 98 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 100 may be configured to access (e.g., write to and/or read from) the memory 102, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the core network node 15 further has software 104 stored internally in, for example, memory 102, or stored in external memory (e.g., database, storage array, network storage device, etc.) accessible by the network node 16 via an external connection. The software 104 may be executable by the processing circuitry 98. The processing circuitry 98 may be configured to control any of the methods and/or processes described herein and/or to cause such methods, and/or processes to be performed, e.g., by core network node 15. Processor 100 corresponds to one or more processors 100 for performing core network node 15 functions described herein. The memory 102 is configured to store data, programmatic software code and/or other information described herein. In some embodiments, the software 104 may include instructions that, when executed by the processor 100 and/or processing circuitry 98, causes the processor 100 and/or processing circuitry 98 to perform the processes described herein with respect to core network node 15. For example, processing circuitry 98 of the core network node 15 may include configuration unit 34 configured to perform one or more core network node 16 functions as described herein such as with respect to network functions when UE AMBR is unavailable.

In some embodiments, the inner workings of the core network node 15, network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as node unit 32, and configuration unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

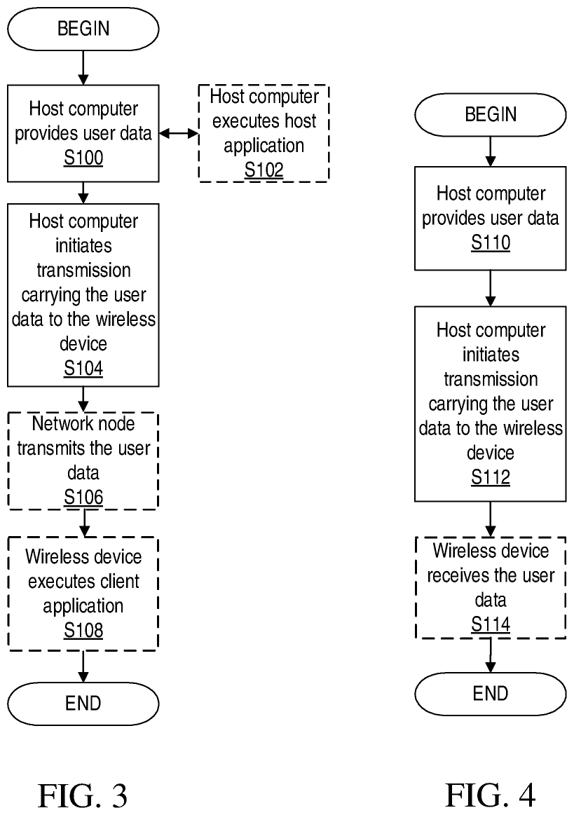

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

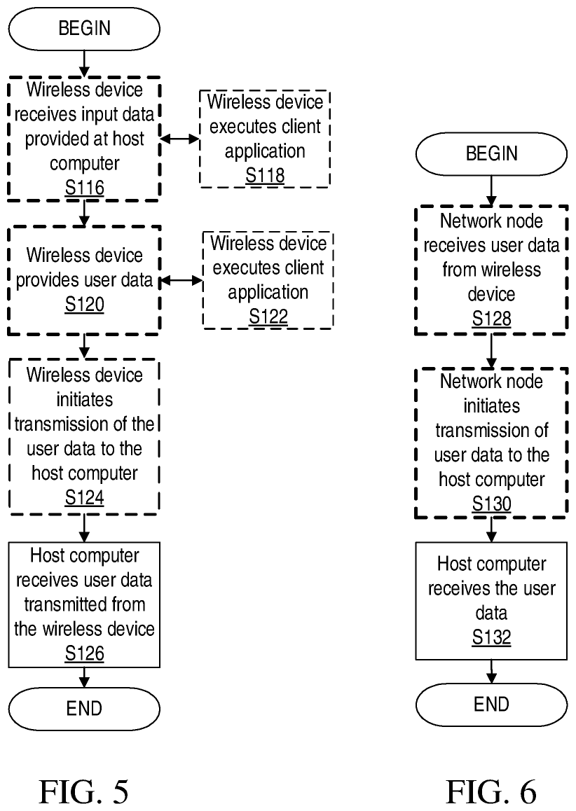

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

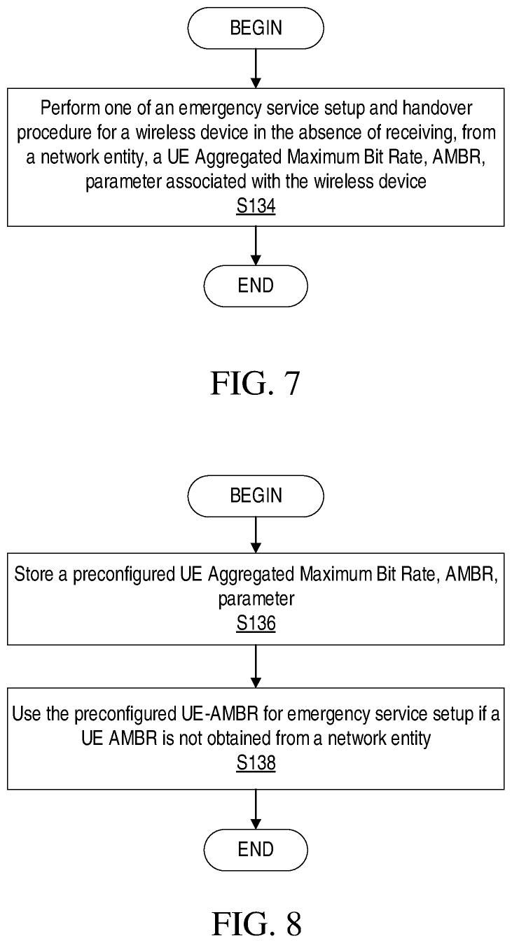

FIG. 7 is a flowchart of an example process in a network node 16 according to some embodiments of the present disclosure. One or more blocks described herein may be performed by one or more elements of network node 16 such as by one or more of processing circuitry 68 (including the node unit 32), processor 70, radio interface 62 and/or communication interface 60. Network node 16 is configured to perform (Block S134) one of an emergency service setup and handover procedure for a wireless device in the absence of receiving, from a network entity (e.g., core network node 15), a UE Aggregated Maximum Bit Rate, AMBR, parameter associated with the wireless device 22, as described herein.

According to one or more embodiments, the processing circuitry 68 is configured to refrain from checking for the UE AMBR for quality of service, QoS, flows associated with one of the emergency service setup and handover procedure.

According to one or more embodiments, processing circuitry 68 is further configured to determine the UE AMBR from a Packet Data Network, PDU, session AMBR where the one of the emergency service setup and handover procedure is performed based on PDU session AMBR.

According to one or more embodiments, processing circuitry 68 is further configured to cause transmission of the determined UE AMBR to the Access and Mobility Management Function, AMF, node in a Next Generation Application Protocol, NGAP, message.

According to one or more embodiments, the network entity is one of a Unified Data Manager, UDM, node and Policy Control Function, PCF, node.

According to one or more embodiments, the network node 16 is configured to use a locally configured UE AMBR for performing one of the emergency service setup and handover procedure for the wireless device 22.

In one or more embodiments, an AMF provides UE AMBR to NG-RAN node. The AMF may receive the UE AMBR from UDM or PCF, but if the UE AMBR is not received from UDM/PCF due to one or more reasons, one of the solutions described herein describes the AMF having a locally configured UE AMBR that can be used for emergency service and provided to NG-RAN.

The other alternatives (if AMF does not provide the UE ABMR at all):
NG-RAN may refrain from the checking of UE AMBR if not provided.
NG-RAN has a locally configured UE AMBR for emergency service where the NG-RAN uses this locally configured UE AMBR.
NG-RAN deduces the UE AMBR from the PDU session AMBR. In this case, the NG-RAN may also need to send the deduced UE AMBR parameter back to the AMF in NGAP messages (e.g., HO Required).

FIG. 8 is a flowchart of an example process in a core network node 15 according to some embodiments of the present disclosure. One or more blocks described herein may be performed by one or more elements of core network node 15 such as by one or more of processing circuitry 98 (including the configuration unit 34), processor 100 and/or communication interface 96. Core network node 15 is configured to store (Block S136) a preconfigured UE Aggregated Maximum Bit Rate, AMBR, parameter, as described herein. Core network node 15 is configured to use (Block S138) the preconfigured UE AMBR for emergency service setup if a wireless AMBR is not obtained from a network entity, as described herein.

According to one or more embodiments, the network entity is one of a Unified Data Manager, UDM, node and Policy Control Function, PCF, node.

According to one or more embodiments, the core network node 15 is an Access and Mobility Management Function, AMF.

According to one or more embodiments, the processing circuitry 98 is further configured to transfer the preconfigured UE AMBR to another core network node during an inter-core network node handover.

According to one or more embodiments, the preconfigured UE AMBR is one of the preconfigured UE AMBR or a UE AMBR configured locally at a network node 16.

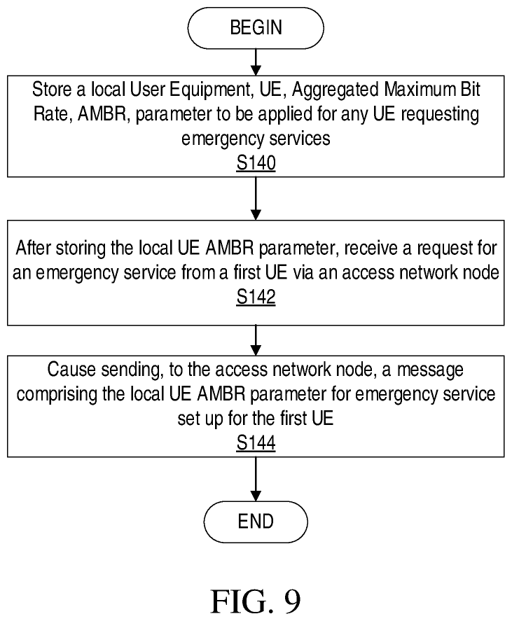

FIG. 9 is a flowchart of another example process in a core network node 15 according to some embodiments of the present disclosure. One or more blocks described herein may be performed by one or more elements of core network node 15 such as by one or more of processing circuitry 98 (including the configuration unit 34), processor 100 and/or communication interface 96. Core network node 15 is configured to store (Block S140) a local User Equipment, UE, Aggregated Maximum Bit Rate, AMBR, parameter to be applied for any UE 22 requesting emergency services, as described herein. Core network node 15 is configured to, after storing the local UE AMBR parameter, receive (Block S142) a request for an emergency service from a first UE 22 via an access network node 16, as described herein. Core network node 15 is configured to send (Block S144), to the access network node 16, a message comprising the local UE AMBR parameter for emergency service set up for the first UE 22, as described herein.

According to one or more embodiments, the core network node 15 is further configured to determine that the core network node 15 does not have stored subscription data for the first UE 22, where the sending of the message comprises the local UE AMBR parameter being based on the determination.

According to one or more embodiments, the sending of the message comprising the local UE AMBR parameter is based on UE AMBR parameter not being obtained from a network entity.

According to one or more embodiments, the network entity is a Unified Data Manager, UDM, node.

According to one or more embodiments, the network entity is a Policy Control Function, PCF, node.

According to one or more embodiments, the core network node 15 is an Access and Mobility Management Function, AMF.

According to one or more embodiments, the emergency service corresponds to an Internet Protocol Multimedia Subsystem, IMS, emergency session.

According to one or more embodiments, the core network node 15 is further configured to: after storing the local UE AMBR parameter, receive a request for an emergency service from a second UE 22 via the access network node 16, and send, to the access network node 16, a message comprising the local UE AMBR parameter for emergency service set up for the second UE 22.

According to one or more embodiments, the local UE AMBR parameter is stored as part of emergency configuration data that are applied to emergency services.

According to one or more embodiments, if the core network node 15 is the AMF, then the core network node 15 provides access to the emergency service.

Having described the general process flow of arrangements of the disclosure and having provided examples of hardware and software arrangements for implementing the processes and functions of the disclosure, the sections below provide details and examples of arrangements for network functions when UE Aggregate Maximum Bit Rate (AMBR) is unavailable.

Some embodiments provide network functions when UE AMBR is unavailable. In one or more embodiments, core network node 15 (e.g., AMF) functions are performed by one or more of processing circuitry 98, processor 100, configuration unit 34, etc. In one or more embodiments, network node 16 (e.g., NG-RAN node) functions may be performed by one or more of processing circuitry 68, processor 70, node unit 32, etc.

The embodiments described herein relate to setup of the emergency service even if the UE AMBR (e.g., wireless device AMBR) is not available in UDM or PCF.

### Example Embodiments at Core Network Node 15 (e.g., AMF)

In one embodiment, the AMF contains the UE AMBR in the Emergency Configuration based on operator decision/configuration when the UE AMBR is unavailable from UDM/PCF (e.g., network entities or other core network nodes 15).

In another embodiment, the AMF may always include UE AMBR, from UDM, PCF, or based on local configuration.

In yet another embodiment, the AMF includes the UE AMBR (either configured or received from RAN) and transfers it to the other AMF during inter-AMF handover, as a result of emergency fallback.

### Example Embodiments at the NG-RAN Node (e.g., Network Node 16)

In one embodiment:

When QoS with 5QI==5 “IMS Signaling” and 5QI==1 “Conversational Voice” are setup from emergency service, the NG-RAN node does not fail the procedure (e.g., performs the procedure) even if UE AMBR is not presented or received or known. The emergency service should be able to setup, or perform emergency service fallback accordingly. An example is shown in Table 1 below which is a modified table in 3GPP Technical Specification (TS) 38.413 chapter 9.2.3.1 that has been modified to allow emergency service even without UE AMBR provided during a PDU session resource setup procedure. The modification is indicated in bold.

In particular, 3GPP TS 38.413, Chapter 8.2.1.2-Successful Operation of PDU Session Resource Setup Procedure, describes that:

The UE Aggregate Maximum Bit Rate Information Element (IE) should be sent to the NG-RAN node if the AMF has not sent it previously. If it is included in the PDU SESSION RESOURCE SETUP REQUEST message, the NG-RAN node stores the UE Aggregate Maximum Bit Rate in the wireless device context, and uses the received UE Aggregate Maximum Bit Rate for all Non-GBR QoS flows for the wireless device as specified in 3GPP TS 23.501.

For emergency service, if the UE Aggregate Maximum Bit Rate is not sent received, and it is not received early, the NG-RAN node skips the enforcement of UE Aggregate Maximum Bit Rate for all Non-GBR QoS flows for the concerned wireless device 22.

TABLE 1

| IE/Group | | | IE type and | Semantics | | Assigned |
|---|---|---|---|---|---|---|
| Name | Presence | Range | reference | description | Criticality | Criticality |
| Message | M | | 9.3.1.1 | | YES | reject |
| Type | | | | | | |
| AMF UE | M | | 9.3.3.1 | | YES | reject |
| NGAP ID | | | | | | |
| RAN UE | M | | 9.3.3.2 | | YES | reject |
| NGAP ID | | | | | | |
| Handover | M | | 9.3.1.22 | | YES | reject |
| Type | | | | | | |
| Cause | M | | 9.3.1.2 | | YES | ignore |
| Target ID | M | | 9.3.1.25 | | YES | reject |
| Direct | O | | 9.3.1.64 | | YES | ignore |
| Forwarding | | | | | | |
| Path | | | | | | |
| Availability | | | | | | |
| PDU | | 1 | | | YES | reject |
| Session | | | | | | |
| Resource | | | | | | |
| List | | | | | | |
| >PDU | | 1 . . . | | | — | |
| Session | | <maxnoofPDUSessions> | | | | |
| Resource | | | | | | |
| Item | | | | | | |
| >>PDU | M | | 9.3.1.50 | | — | |
| Session | | | | | | |
| ID | | | | | | |
| >>Hand | M | | OCTET | Containing | — | |
| over | | | STRING | the | | |
| Required | | | | Handover | | |
| Transfer | | | | Required | | |
| | | | | Transfer IE | | |
| | | | | specified in | | |
| | | | | subclause | | |
| | | | | 9.3.4.14. | | |
| Source to | M | | 9.3.1.20 | | YES | reject |
| Target | | | | | | |
| Transparent | | | | | | |
| Container | | | | | | |
| NG-RAN | O | | WD | | YES | ignore |
| UE AMBR | | | Aggregate | | | |
| | | | Maximum | | | |
| | | | Bit Rate | | | |
| | | | 9.3.1.58 | | | |

In another embodiment, if the Emergency Service is setup in 5G without UE AMBR provided from AMF, the UE AMBR limitation is not checked by, for example, network node 16. The emergency service is setup with all the requested QoS fulfilled. See Table 1.

In yet another embodiment, the NG-RAN node will “configure” UE AMBR parameters. The UE AMBR parameters are configured to be “big enough” to facilitate emergency service, as described herein.

In yet another embodiment, the NG-RAN node can use the PDU session level AMBR parameters as the UE AMBR parameters, either by local configuration or calculation.

In yet another embodiment, when the Emergency Fallback is to be performed, the NG-RAN node is able to include the “configured UE AMBR” if the UE AMBR is not provided by AMF. The “configured UE AMBR” could either be configured in OAM, or calculated by NG-RAN node, for example, UE AMBR=SUM (PDU Session AMBR). The configured UE AMBR is sent from the source NG-RAN node to AMF. The AMF uses it and sends it to the target NG-RAN node. See Table 2 (NG-RAN to include “NG-RAN UE AMBR” (based on configuration or calculation) to AMF in handover preparation).

TABLE 2

| Range bound | Explanation |
|---|---|
| maxnoofPDUSessions | Maximum no. of PDU sessions allowed towards |
| | one WD. Value is 256. |

In yet another embodiment, during Intra system handover for emergency fallback, the target NG-RAN node proceeds with the emergency service handover without UE AMBR being received from AMF, similar to the described above emergency service setup procedure (no UE AMBR limitation checking, use a local configured UE AMBR, or use the PDU session AMBR as the UE AMBR).

In yet another embodiment, the handover request message is updated so that the UE AMBR presence is changed from “Mandatory” to “optional”. See Table 3 that is a modified table in 3GPP TS 38.413 Chapter 9.2.3.4 (Direction: AMF->NG-RAN node). The modification in Table 3 are indicated in bold and strikethrough where “M” is mandatory and “O” is optional.

TABLE 3

| | | | | | | |
|---|---|---|---|---|---|---|
| IE/Group | | | IE type and | Semantics | | Assigned |
| Name | Presence | Range | reference | description | Criticality | Criticality |

| | | | | |
|---|---|---|---|---|
| Message | M | 9.3.1.1 | YES | reject |
| Type | | | | |
| AMF WD | M | 9.3.3.1 | YES | reject |
| NGAP ID | | | | |
| Handover | M | 9.3.1.22 | YES | reject |
| Type | | | | |
| Cause | M | 9.3.1.2 | YES | ignore |
| WD | [symbol] O | 9.3.1.58 | YES | reject |
| Aggregate | | | | |
| Maximum | | | | |
| Bit Rate | | | | |
| Core | O | 9.3.1.15 | YES | ignore |
| Network | | | | |
| Assistance | | | | |
| Information | | | | |
| for RRC | | | | |
| INACTIVE | | | | |

*Unchanged rows skipped

In yet another embodiment, in the split NG-RAN architecture, it is specified that gNB-CU (e.g., network node-CU) may configure a UE AMBR (in the case that UE AMBR is not received) and send it over to gNB-DU (e.g., network node-DU) during context setup. A similar approach over may be used over Xn and E1 interfaces.

Alternatively, in the emergency service setup or handover procedure, missing UE AMBR is allowed. This may lead to the change of XnAP, F1AP and/or E1AP where the UE AMBR IE presence is changed from mandatory to optional, similar to Table 3.

One or more embodiments described herein may be included in one or more of the following 3GPP standards: 3GPP TS 38.413, 3GPP TS 23.501, 3GPP TS 38.473, 3GPP TS 38.423 and 3GPP TS 37.473.

Hence, one or more embodiments described herein provide for emergency service to setup even without UE AMBR being available (e.g., emergency service setup irrespective of UE AMBR availability).

### Some Examples:

Core Network Node 15 (e.g. AMF) example:
The AMF can contain the UE AMBR in the Emergency Configuration based on network operator decision such as if the UE AMBR is not available from UDM/PCF.
Another approach, the AMF always include UE AMBR obtained from UDM, PCF, or based on local configuration.
The AMF either uses the configured UE AMBR or in case the NG-RAN node (e.g., network node 16) uses its locally configured UE AMBR (e.g., the one received from NG-RAN node) and transfers the UE AMBR to another AMF during inter AMF handover, when UE AMBR is not available.

NG-RAN node (e.g., network node 16) examples:
The NG-RAN node does not fail the emergency service setup or handover procedures even if UE AMBR is not presented.
In the above case, there may be no check on UE AMBR for the QoS flows.
Alternatively, it is specified that NG-RAN node uses a locally configured UE AMBR. Another alternative is that NG-RAN node can use the PDU session AMBR as the UE AMBR.
For the above alternatives, where NG-RAN node formulates the UE AMBR, RAN can provide the UE AMBR to AMF in NGAP response or Handover Required message. The AMF stores the value in WD context and transfers the value between AMFs during mobility. This supports the emergency fallback with handover.
In the split NG-RAN node architecture, gNB-CU may configure a UE AMBR (in cases where UE AMBR is not received) and send it over to gNB-DU during context setup. A similar approach can be used over Xn and E1 interfaces.
Alternatively, in the emergency service setup or handover procedure, missing UE AMBR is allowed, e.g., predefined in the specification as being allowed.

One advantage provided by the teachings of the present disclosure is that emergency service (e.g., emergency service via a wireless device) may be setup or provided according to the regulation even without UE AMBR being available.

According to one or more embodiments, to support the emergency registration for a UE that does not have subscription data in AMF (e.g., unauthenticated UE or the subscription data retrieval from UDM fails), the AMF/SMF utilizes the local emergency configuration data to setup UE context and PDU session resources at the RAN side. The UE-AMBR is part of the UE context needed at the RAN side. AMF emergency configuration data may include UE-AMBR; otherwise, emergency resource setup may fail. For example, UE AMBR may be mandatory when non-GBR QoS flows are setup. When the UE is not able to register to the network, or it does not have UICC, thus no UDM records, this UE, by regulation, should be allowed to set up emergency service, but it does not have UE AMBR. When 5QI 5 “IMS Signaling”, the non-GBR service is setup, NG-RAN node will fail the procedure. The Network should provide support for the emergency service during this condition. Hence, one or more embodiments described herein specifies that a NG-RAN node will permit the emergency service when UE AMBR is not provided, and the UE AMBR checking is skipped. The mandatory presence of UE AMBR in Handover Request is changed to Optional.

In other words, the UE Aggregate Maximum Bit Rate IE should be sent to the NG-RAN node if the AMF has not sent it previously. If it is included in the PDU SESSION RESOURCE SETUP REQUEST message, the NG-RAN node stores the UE Aggregate Maximum Bit Rate in the UE context and uses the received UE Aggregate Maximum Bit Rate for all Non-GBR QoS flows for the concerned UE. For emergency service, if the UE Aggregate Maximum Bit Rate is not sent received, and it is not received early, the NG-RAN node skips the enforcement of UE Aggregate Maximum Bit Rate for all Non-GBR QoS flows for the concerned UE.

According to one or more embodiments, to provide Emergency Services, the AMF is configured with Emergency Configuration Data that are applied to Emergency Services that are established by an AMF based on request from the UE. The AMF Emergency Configuration Data contains the S-NSSAI and Emergency DNN which is used to derive an SMF. In addition, the AMF Emergency Configuration Data may contain the statically configured SMF for the Emergency DNN. The SMF may also store Emergency Configuration Data that contains statically configured UPF information for the Emergency DNN. The AMF Emergency Configuration Data can also contain UE-AMBR.

According to one or more embodiments, upon receipt of the INITIAL CONTEXT SETUP REQUEST message the NG-RAN node is configured to:
attempt to execute the requested PDU session configuration;
store the received UE Aggregate Maximum Bit Rate in the UE context, and use the received UE Aggregate Maximum Bit Rate for Non-GBR QoS flows for the concerned UE as specified in 3GPP TS 23.501. For emergency service, if the UE Aggregate Maximum Bit Rate is not sent received, and it is not received early, the NG-RAN node shall skip the enforcement of UE Aggregate Maximum Bit Rate for all Non-GBR QoS flows for the concerned UE;
store the received Mobility Restriction List in the UE context; and/or
store the received UE Radio Capability in the UE context.

According to one or more embodiments, upon receipt of the HANDOVER REQUEST message the target NG-RAN node is configured to:
attempt to execute the requested PDU session configuration and associated security;
store the received UE Aggregate Maximum Bit Rate in the UE context, and use the received UE Aggregate Maximum Bit Rate for all Non-GBR QoS flows for the concerned UE as specified in 3GPP TS 23.501. For emergency service, if the UE Aggregate Maximum Bit Rate is not sent/received, and it is not received early, the NG-RAN node shall skip the enforcement of UE Aggregate Maximum Bit Rate for all Non-GBR QoS flows for the concerned UE;
store the received Mobility Restriction List in the UE context; and/or
store the received UE Security Capabilities in the UE context.

### Some Additional Examples

Example A1. A network node 16 configured to and/or comprising a radio interface 62 and/or comprising processing circuitry 68 configured to:
perform one of an emergency service setup and handover procedure for a wireless device 22 in the absence of receiving, from a network entity, a User Equipment, UE, Aggregated Maximum Bit Rate, AMBR, parameter associated with the wireless device 22.

Example A2. The network node 16 of Example A1, wherein the processing circuitry 68 is configured to refrain from checking for the UE AMBR for quality of service, QoS, flows associated with one of the emergency service setup and handover procedure.

Example A3. The network node 16 of Example A1, wherein processing circuitry 68 is further configured to determine the UE AMBR from a Packet Data Network, PDU, session AMBR; and
the one of the emergency service setup and handover procedure being performed based on PDU session AMBR.

Example A4. The network node 16 of Example A3, wherein the processing circuitry 68 is further configured to cause transmission of the determined UE AMBR to the Access and Mobility Management Function, AMF, node in a Next Generation Application Protocol, NGAP, message.

Example A5. The network node 16 of Example A1, wherein the network entity is one of a Unified Data Manager, UDM, node and Policy Control Function, PCF, node.

Example A6. The network node 16 of Example A1, wherein the network node 16 is configured to use a locally configured UE AMBR for performing one of the emergency service setup and handover procedure for the wireless device 22.

Example B1. A method implemented in a network node 16, the method comprising:
performing one of an emergency service setup and handover procedure for a wireless device 22 in the absence of receiving, from a network entity, a User Equipment, UE, Aggregated Maximum Bit Rate, AMBR, parameter associated with the wireless device 22.

Example B2. The method of Example B1, further comprising refraining from checking for the UE AMBR for quality of service, QoS, flows associated with one of the emergency service setup and handover procedure.

Example B3. The method of Example B1, further comprising determining the UE AMBR from Packet Data Network, PDU, session AMBR; and the one of the emergency service setup and handover procedure being performed based on PDU session AMBR.

Example B4. The method of Example B1, further comprising causing transmission of the determined UE AMBR to the Access and Mobility Management Function, AMF, node in a Next Generation Application Protocol, NGAP, message.

Example B5. The method of Example B1, wherein the network entity is one of a Unified Data Manager, UDM, node and Policy Control Function, PCF, node.

Example B6. The method of Example B1, wherein the network node 16 is configured to use a locally configured UE AMBR for performing one of the emergency service setup and handover procedure for the wireless device 22.

Example C1. A core network node 15 configured to, and/or comprising a radio interface and/or processing circuitry 98 configured to:
store a preconfigured User Equipment, UE, Aggregated Maximum Bit Rate, AMBR, parameter; and
use the preconfigured UE AMBR for emergency service setup if a UE AMBR is not obtained from a network entity.

Example C2. The core network node 15 of Example C1, wherein the network entity is one of a Unified Data Manager, UDM, node and Policy Control Function, PCF, node.

Example C3. The core network node 15 of Example C1, wherein the core network node 15 is an Access and Mobility Management Function, AMF.

Example C4. The core network node 15 of Example C1, wherein the processing circuitry 98 is further configured to transfer the preconfigured UE AMBR to another core network node 15 during an inter-core network node handover.

Example C5. The core network node 15 of Example C4, wherein the preconfigured UE AMBR is one of the preconfigured UE AMBR or a UE AMBR configured locally at a network node 16.

Example D1. A method implemented in a core network node 15, the method comprising:
storing a preconfigured User Equipment, UE, Aggregated Maximum Bit Rate, AMBR, parameter; and
using the preconfigured UE AMBR for emergency service setup if a UE AMBR is not obtained from a network entity.

Example D2. The method of Example D1, wherein the network entity is one of a Unified Data Manager, UDM, node and Policy Control Function, PCF, node.

Example D3. The method of Example D1, wherein the core network node 15 is an Access and Mobility Management Function, AMF.

Example D4. The method of Example D1, further comprising transferring the preconfigured UE AMBR to another core network node 15 during an inter-core network node handover.

Example D5. The method of Example D4, wherein the preconfigured UE AMBR is one of the preconfigured UE AMBR or a UE AMBR configured locally at a network node 16.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| CN | Core Network |
| AMF | Access and Mobility Management Function |
| CP | Control Plane |
| CU | Central Unit |
| CU-CP | Central Unit Control Plane |
| CU-UP | Central Unit User Plane |
| UE AMBR | UE Aggregate Maximum Bit Rate |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A core network node, comprising:
processing circuitry configured to:
store a local User Equipment, UE, Aggregated Maximum Bit Rate, AMBR, parameter to be applied for any UE requesting emergency services;
after storing the local UE AMBR parameter, receive a request for an emergency service from a first UE via an access network node; and
cause sending, to the access network node, a message comprising the local UE AMBR parameter for emergency service set up for the first UE.

2. The core network node of claim 1, wherein the processing circuitry is further configured to determine that the core network node does not have stored subscription data for the first UE, the sending of the message comprising the local UE AMBR parameter being based on the determination.

3. The core network node of claim 1, wherein the sending of the message comprising the local UE AMBR parameter is based on a UE AMBR parameter not being obtained from a network entity.

4. The core network node of claim 3, wherein the network entity is a Unified Data Manager, UDM, node.

5. The core network node of claim 3, wherein the network entity is a Policy Control Function, PCF, node.

6. The core network node of claim 1, wherein the core network node is an Access and Mobility Management Function, AMF.

7. The core network node of claim 1, wherein the emergency service corresponds to an Internet Protocol Multimedia Subsystem, IMS, emergency session.

8. The core network node of claim 1, wherein the processing circuitry is further configured to:
after storing the local UE AMBR parameter, receive a request for an emergency service from a second UE via the access network node;
cause sending, to the access network node, a message comprising the local UE AMBR parameter for emergency service set up for the second UE.

9. The core network node of claim 1, wherein the local UE AMBR parameter is stored as part of emergency configuration data that are applied to emergency services.

10. A method implemented by a core network node, the method comprising:
storing a local User Equipment, UE, Aggregated Maximum Bit Rate, AMBR, parameter to be applied for any UE requesting emergency services;
after storing the local UE AMBR parameter, receiving a request for an emergency service from a first UE via an access network node; and
sending, to the access network node, a message comprising the local UE AMBR parameter for emergency service set up for the first UE.

11. The method of claim 10, further comprising determining that the core network node does not have stored subscription data for the first UE, the sending of the message comprising the local UE AMBR parameter being based on the determination.

12. The method of claim 10, wherein the sending of the message comprising the local UE AMBR parameter is based on a UE AMBR parameter not being obtained from a network entity.

13. The method of claim 12, wherein the network entity is a Unified Data Manager, UDM, node.

14. The method of claim 12, wherein the network entity is a Policy Control Function, PCF, node.

15. The method of claim 10, wherein the core network node is an Access and Mobility Management Function, AMF.

16. The method of claim 10, wherein the emergency service corresponds to an Internet Protocol Multimedia Subsystem, IMS, emergency session.

17. The method of claim 10, further comprising after storing the local UE AMBR parameter, receiving a request for an emergency service from a second UE via the access network node.

18. The method of claim 17, further comprising sending, to the access network node, a message comprising the local UE AMBR parameter for emergency service set up for the second UE.

19. The method of claim 10, wherein the local UE AMBR parameter is stored as part of emergency configuration data that are applied to emergency services.

20. A computer readable storage medium storing program instructions that, when executed by a processor, configure the processor to:
store a local User Equipment, UE, Aggregated Maximum Bit Rate, AMBR, parameter to be applied for any UE requesting emergency services;
after storing the local UE AMBR parameter, receive a request for an emergency service from a first UE via an access network node; and
send, to the access network node, a message comprising the local UE AMBR parameter for emergency service set up for the first UE.
